(19) United States
(12) Patent Application Publication
(10) Pub. No.: US 2023/0113116 A1
(43) Pub. Date: Apr. 13, 2023

(54) TERMINAL

(71) Applicant: NTT DOCOMO, INC., Tokyo (JP)

(72) Inventors: Yuki Takahashi, Tokyo (JP); Yuki Matsumura, Tokyo (JP); Hiroki Harada, Tokyo (JP)

(73) Assignee: NTT DOCOMO, INC., Tokyo (JP)

(21) Appl. No.: 17/913,713

(22) PCT Filed: Mar. 23, 2020
(86) PCT No.: PCT/JP2020/012781

§ 371 Date: Sep. 22, 2022

(51) Int. Cl. H04W 76/27

(52) U.S. Cl. CPC H04W 76/27

(57) ABSTRACT

A terminal includes: a receiving unit that receives downlink control information from a network; and a controller that, when a component carrier group formed from a plurality of component carriers is activated or applied, uses the downlink control information received via any one of the plurality of component carriers to control communication among the plurality of component carriers.

### TECHNICAL FIELD

The present disclosure relates to a terminal that performs radio communication, and particularly to a terminal that performs radio communication using a large number of component carriers.

### BACKGROUND ART

The 3rd Generation Partnership Project (3GPP) has specified the 5th generation mobile communication system (5G, also called New Radio (NR) or Next Generation (NG)), and is proceeding with specification of the next-generation called Beyond 5G, 5G Evolution or 6G.

Release 15 and Release 16 (NR) of 3GPP specify the operations of a plurality of frequency ranges, specifically, bands including FR1 (410 MHz to 7.125 GHz) and FR2 (24.25 GHz to 52.6 GHz).

3GPP is also contemplating specification of NR that supports the frequency band exceeding 52.6 GHz, up to 71 GHz (Non-Patent Literature 1). Further, 3GPP is aiming at supporting the frequency band exceeding 71 GHz by Beyond 5G, 5G Evolution or 6G (Release-18 or later).

### CITATION LIST

### Non-Patent Literature

Non-Patent Literature 1: “New WID on Extending current NR operation to 71 GHz”, RP-193229, 3GPP TSG RAN Meeting #86, 3GPP, December 2019.

### SUMMARY OF INVENTION

As described above, it is assumed that when the usable frequency band is expanded, more component carriers (CC) are likely to be set.

Under Carrier Aggregation (CA), the number of settable CCs is prescribed. For example, in Release 15 and Release 16 of 3GPP, the maximum number of CCs settable for a terminal (user equipment (UE)) is 16 in each of downlink (DL) and uplink (UL).

On the other hand, the physical layer and medium access control layer (MAC) are set for each CC. For example, one piece of downlink control information (DCI) can schedule only one CC. Thus, a large number of DCIs are required to schedule a large number of CCs.

In particular, in the case of cross-carrier scheduling in which scheduling is applied across a plurality of CCs, the capacity of physical downlink control channel (PDCCH) used for DCI transmission may become scarce.

Therefore, the following disclosure has been made in view of such circumstances. An object of the disclosure is to provide a terminal that realizes efficient CC communication control using downlink control information (DCI), even if a large number of component carriers (CC) is set.

One aspect of the present disclosure is a terminal that includes: a receiving unit that receives downlink control information from a network; and a controller that, when a component carrier group formed from a plurality of component carriers is activated or applied, uses the downlink control information received via any one of the plurality of component carriers to control communication among the plurality of component carriers.

### BRIEF DESCRIPTION OF DRAWINGS

FIG. 1 is an overall schematic configuration diagram of a radio communication system 10.

FIG. 2 is a diagram illustrating frequency ranges used in the radio communication system 10.

FIG. 3 is a diagram illustrating a configuration example of radio frames, subframes, and slots used in the radio communication system 10.

FIG. 4 is a functional block configuration diagram of a UE 200.

FIG. 5 is a diagram for explaining a CC group.

FIG. 6 is a diagram for explaining a CC group.

FIG. 7 is a diagram for explaining DCI.

FIG. 8 is a diagram for explaining a scheduling example.

FIG. 9 is a diagram for explaining a scheduling example.

FIG. 10 is a diagram for explaining a scheduling example.

FIG. 11 is a diagram for explaining a scheduling example.

FIG. 12 is a diagram illustrating a first operation example.

FIG. 13 is a diagram illustrating a second operation example.

FIG. 14 is a diagram illustrating a third operation example.

FIG. 15 is a diagram illustrating a fourth operation example.

FIG. 16 is a diagram illustrating an example of a hardware configuration of the UE 200.

### DESCRIPTION OF EMBODIMENTS

Embodiments will be described below with reference to the drawings. The same functions and configurations are designated by the same or similar reference numerals, and description thereof will be omitted as appropriate.

### Embodiment

### (1) OVERALL SCHEMATIC CONFIGURATION OF A RADIO COMMUNICATION SYSTEM

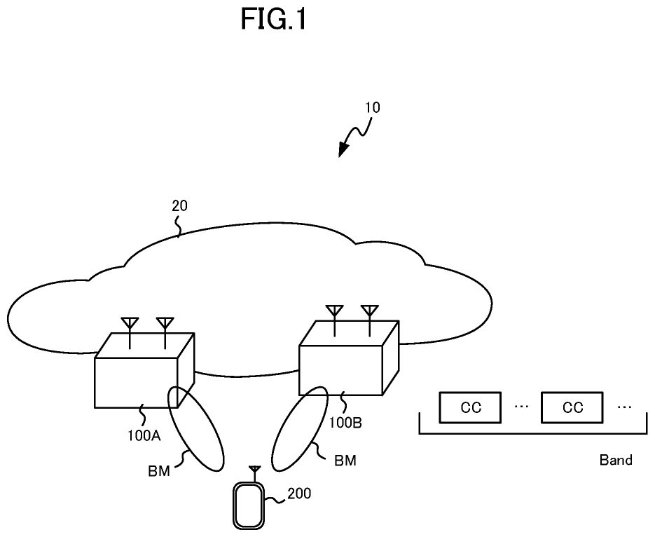

FIG. 1 is an overall schematic configuration diagram of a radio communication system 10 according to the present embodiment. The radio communication system 10 is a radio communication system in compliance with 5G New Radio (NR), and includes a next generation-radio access network 20 (hereinafter, NG-RAN 20) and a terminal 200 (hereinafter, UE 200).

The radio communication system 10 may be a radio communication system according to a scheme called Beyond 5G, 5G Evolution, or 6G.

The NG-RAN 20 includes a radio base station 100A (hereinafter, gNB 100A) and a radio base station 100B (hereinafter, gNB 100B). A specific configuration of the radio communication system 10 including the numbers of gNBs and UEs is not limited to the example illustrated in FIG. 1.

The NG-RAN 20 actually includes a plurality of NG-RAN nodes, specifically, gNBs (or ng-eNBs), and is connected to a 5G-compliant core network (SGC, not illustrated). The NG-RAN 20 and 5GC may be simply expressed as “network”.

The gNB 100 and the gNB 100B are 5G-compliant radio base stations, and perform radio communication according to the UE 200 and 5G. The gNB 100, gNB 100B, and UE 200 can control radio signals transmitted from a plurality of antenna elements to support massive multiple-input multiple-output (MIMO) that generates a beam BM with higher directivity, carrier aggregation (CA) in which a plurality of component carriers (CCs) is bundled together, and dual connectivity (DC) in which simultaneous communication is performed between the UE and each of the two NG-RAN nodes, and the like.

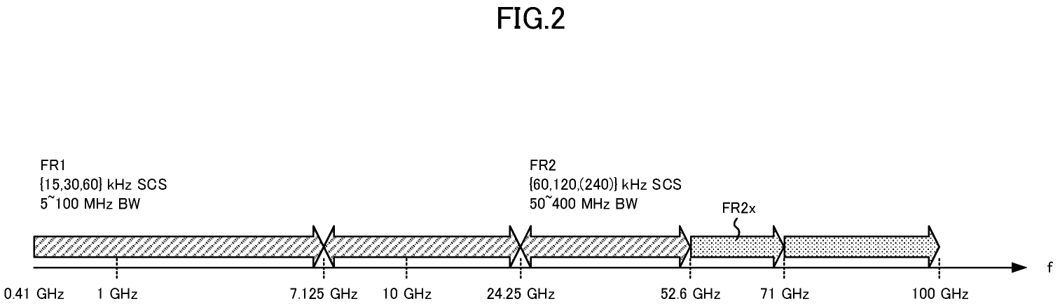

The radio communication system 10 supports a plurality of frequency ranges (FRs). FIG. 2 illustrates frequency ranges used in the radio communication system 10.

As illustrated in FIG. 2, the radio communication system 10 supports FR1 and FR2. The respective frequency bands of the FRs are as follows.
FR1: 410 MHz to 7.125 GHz
FR2: 24.25 GHz to 52.6 GHz

In the FR1, a sub-carrier spacing (SCS) of 15, 30, or 60 kHz may be used, and a bandwidth (BW) of 5 to 100 MHz may be used. The FR2 is higher in frequency than the FR1, a SCS of 60 or 120 kHz (240 kHz may be included) may be used, and a bandwidth (BW) of 50 to 400 MHz may be used.

SCS may be interpreted as numerology. The numerology is defined in 3GPP TS38.300 and corresponds to one subcarrier spacing in the frequency domain.

Further, the radio communication system 10 also supports a higher frequency band than the FR2 frequency band. Specifically, the radio communication system 10 supports a frequency band of greater than 52.6 GHz and up to 114.25 GHz. Such a high frequency band may be called “FR2x” for convenience.

In order to solve such an issue, when a band exceeding 52.6 GHz is to be used, cyclic prefix-orthogonal frequency division multiplexing (CP-OFDM)/discrete Fourier transform-spread (DFT-S-OFDM)) having a larger sub-carrier spacing (SCS) may be applied.

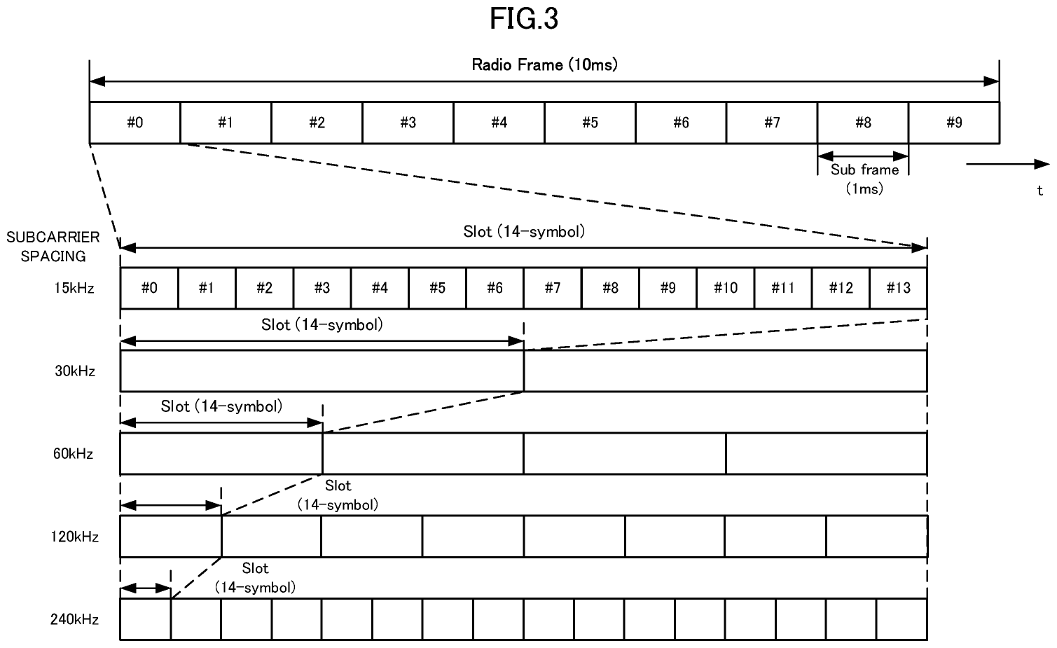

FIG. 3 illustrates a configuration example of radio frames, subframes, and slots used in the radio communication system 10.

As illustrated in FIG. 3, one slot is composed of 14 symbols, and the larger (wider) the SCS becomes, the shorter the symbol period (and the slot period) becomes. The SCS is not limited to the intervals (frequency) illustrated in FIG. 3. For example, 480 kHz, 960 kHz or the like may be used.

The number of symbols forming one slot does not necessarily have to be 14 symbols (for example, 28 or 56 symbols). The number of slots per subframe may vary depending on the SCS.

Time direction (t) illustrated in FIG. 3 may be called time domain, symbol period, symbol time, or the like. Further, the frequency direction may be called frequency domain, resource block, subcarrier, bandwidth part (BWP), or the like.

### (2) FUNCTIONAL BLOCK CONFIGURATION OF THE RADIO COMMUNICATION SYSTEM

Next, a functional block configuration of the radio communication system 10 will be described. Specifically, the functional block configuration of the UE 200 will be described.

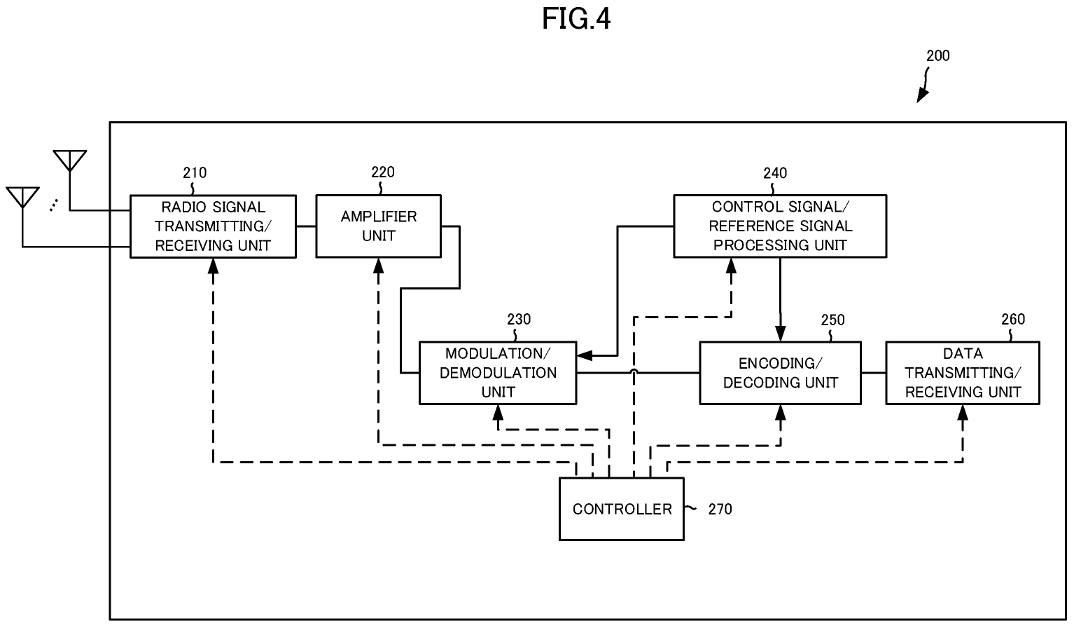

FIG. 4 is a functional block configuration diagram of the UE 200. As illustrated in FIG. 4, the UE 200 includes a radio signal transceiver 210, an amplifier 220, a modulator/demodulator 230, a control signal/reference signal processor 240, an encoder/decoder 250, a data transceiver 260, and a controller 270.

The radio signal transceiver 210 transmits/receives a radio signal according to the NR. The radio signal transceiver 210 is compatible with Massive MIMO, CA using a bundle of CCs, DC performing simultaneous communication between the UE and each of the two NG-RAN nodes, and the like.

In the embodiment, the radio signal transceiver 210 constitutes a receiver that receives downlink control information (DCI) from the network (NG-RAN 20).

The amplifier 220 includes a power amplifier (PA)/low noise amplifier (LNA) or the like. The amplifier 220 amplifies the signal output from the modulator/demodulator 230 to a predetermined power level. The amplifier 220 amplifies the RF signal output from the radio signal transceiver 210.

The modulator/demodulator 230 executes data modulation/demodulation, transmission power setting, resource block allocation, and the like for each predetermined communication destination (the gNB 100 or another gNB). In the modulator/demodulator 230, cyclic prefix-orthogonal frequency division multiplexing (CP-OFDM)/discrete Fourier transform-spread (DFT-S-OFDM)) may be applied. DFT-S-OFDM may be used not only in the uplink (UL) but also in the downlink (DL).

The control signal/reference signal processor 240 executes processing regarding various control signals transmitted and received by the UE 200 and processing regarding various reference signals transmitted and received by the UE 200.

Specifically, the control signal/reference signal processor 240 receives various control signals transmitted from the gNB 100 via a predetermined control channel, for example, a control signal for the radio resource control layer (RRC). The control signal/reference signal processor 240 transmits various control signals to the gNB 100 via a predetermined control channel.

The control signal/reference signal processor 240 executes processing using reference signals (RS) such as a demodulation reference signal (DMRS) and a phase tracking reference signal (PTRS).

The DMRS is a known reference signal (pilot signal) between a base station and each terminal for estimating a fading channel used for data demodulation. The PTRS is a terminal-specific reference signal for the purpose of estimating phase noise, which is a problem in high frequency bands.

The reference signals may include channel state information-reference signal (CSI-RS), sounding reference signal (SRS), and positioning reference signal (PRS) for position information, in addition to DMRS and PTRS.

The channels include control channels and data channels. The control channels include physical downlink control channel (PDCCH), physical uplink control channel (PUCCH), random access channel (RACH), downlink control information (DCI) including random access radio network temporary identifier (RA-RNTI), physical broadcast channel (PBCH), and the like.

The data channel includes physical downlink shared channel (PDSCH), physical uplink shared channel (PUSCH), and the like. The data here means data transmitted via a data channel. The data channel may be interpreted as a shared channel.

The encoder/decoder 250 executes data division/concatenation, channel coding/decoding, and the like for each predetermined communication destination (the gNB 100 or another gNB).

Specifically, the encoder/decoder 250 divides the data output from the data transceiver 260 into a predetermined size, and executes channel coding on the divided data. The encoder/decoder 250 decodes the data output from the modulator/demodulator 230 and connects the decoded data.

The data transceiver 260 executes transmission/reception of protocol data unit (PDU) and service data unit (SDU). Specifically, the data transceiver 260 assembles/disassembles PDU/SDU in a plurality of layers (medium access control layer (MAC)), radio link control layer (RLC), packet data convergence protocol layer (PDCP), and the like. The data transceiver 260 executes data error correction and retransmission control based on hybrid automatic repeat request (ARQ).

The controller 270 controls functional blocks constituting the UE 200. In particular, in the present embodiment, when a component carrier group (hereinafter, CC group) formed by a plurality of CCs is applied, the controller 270 uses the DCI received via any one of the plurality of CCs to control the communication among the plurality of CCs.

### (3) CC GROUP

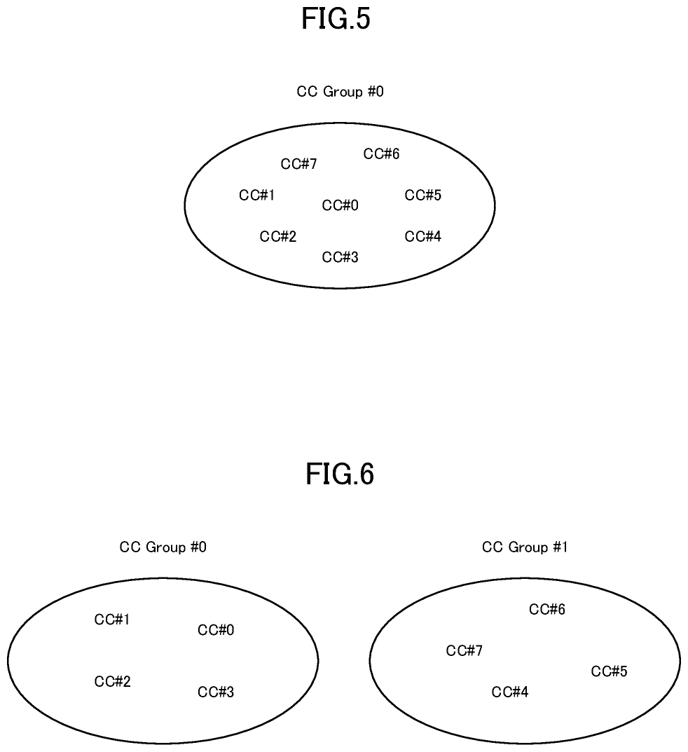

FIGS. 5 and 6 are diagrams for explaining the CC group according to the present embodiment. As described above, the CC group includes a plurality of CCs.

As illustrated in FIG. 5, one CC group may be set. FIG. 5 illustrates a case where a CC group #0 is set to CC #0 to CC #7. The CC group #0 may be called serving cell group. The CC group #0 may be set by upper layer parameters. For example, the CC group #0 may be set by an RRC message. In the case of setting one CC group, a plurality of CCs to be included in the CC group may be predetermined.

As illustrated in FIG. 6, a plurality of CC groups may be set. FIG. 6 illustrates a case where a CC group #0 is set to CC #0 to CC #3 and a CC group #1 is set to CC #4 to CC #7. The CC group #0 and the CC group #1 may be called serving cell groups. The CC group #0 and the CC group #1 may be set by upper layer parameters. For example, the CC group #0 and the CC group #1 may be set by an RRC message.

Referring to FIGS. 5 and 6, the CC group may be applied to the UE 200 by the information element included in the RRC message or may be applied to the UE 200 by the information element included in the DCI. The CC group applied to the UE 200 may be a CC group selected from the CC groups set by upper layer parameters. The applied may be called enable or activate.

Similarly, the CC group may not be applied to the UE 200 by the information element included in the RRC message, and may not be applied to the UE 200 by the information element included in the DCI. The CC group that is not applied to the UE 200 may be a CC group selected from the CC groups set by upper layer parameters. The non-applied may be called disable or inactivate.

First, a plurality of CCs included in a CC group may be CCs that are consecutive in the intra-band. The plurality of CCs included in the CC group may be CCs included in a scheduling cell or may be CCs included in a search space of the PDCCH. The search space of the PDCCH may be defined by an RNTI such as system information (SI)-radio network temporary identifier (RNTI), random access (RA)-RNTI, temporary cell (TC)-RNTI, cell (C)-RNTI, paging (P)-RNTI, interruption (INT)-RNTI, slot format indication (SFI)-RNTI, transmit power control (TPC)-PUSCH-RNTI, TPC-PUCCH-RNTI, TPC-SRS-RNTI, and semi persistent (SP)-channel state information (CSI)-RNTI. The plurality of CCs included in the CC group may be CCs to which the settings of a serving cell is commonly applied. The settings of the serving cell may include TDD DL/UL configuration and SCS specific carrier list.

Second, a CC group may be set and applied for one purpose or operation. The CC group may be set and applied for two or more purposes or operations. The predetermined purpose or operation may include UL scheduling, DL scheduling, BWP switching, transmission configuration indicator (TCI) switching, and slot format indicator (SFI).

A case where a CC group is set and applied for one purpose or operation will be described with reference to FIG. 6. For example, the CC group #0 may be a group for UL scheduling and the CC group #1 may be a group for DL scheduling. The CC group #0 may be a group for scheduling (UL and DL), and the CC group #1 may be a group for BWP switching. The CC group #0 may be a group for TCI switching, and the CC group #1 may be a group for SFI. According to such a configuration, it is possible to flexibly set the CC groups, thereby achieving performance improvement.

A case where a CC group is set and applied for two or more purposes or operations will be described with reference to FIG. 6. For example, the CC group #0 may be a group for scheduling (UL and DL) and SFI, and the CC group #1 may be a group for BWP switching and TCI switching. According to such a configuration, it is possible to simplify the configuration of the gNB 100.

### (4) DCI

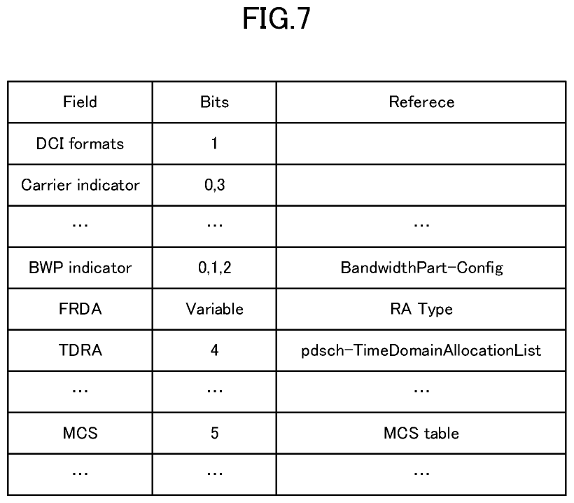

FIG. 7 is a diagram for explaining the DCI according to the embodiment. FIG. 7 illustrates a part of DCI format 1_0.

The DCI includes fields for storing DCI formats, carrier indicator (CI), BWP indicator, frequency domain resource allocation (FDRA), time domain resource allocation (TDRA), modulation and coding scheme (MCS), and the like.

The value stored in the DCI format field is an information element that specifies the DCI format. The value stored in the CI field is an information element that specifies the CC to which the DCI is applied. The value stored in the BWP indicator field is an information element that specifies the BWP to which the DCI is applied. The BWP that can be specified by the BWP indicator is set by an information element (BandwidtPart-Config) included in the RRC message. The value stored in the FDRA field is an information element that specifies the frequency domain resource to which the DCI is applied. The frequency domain resource is specified by the value stored in the FDRA field and the information element (RA Type) included in the RRC message. The value stored in the TDRA field is an information element that specifies the time domain resource to which the DCI is applied. The time domain resource is specified by the value stored in the TDRA field and the information element (pdsch-TimeDomainAllocationList) included in the RRC message. The time domain resource may be specified by the value stored in the TDRA field and the default table. The value stored in the MCS is an information element that specifies MCS to which the DCI is applied. The MCS is specified by the value stored in the MCS and the MCS table. The MCS table may be specified by the RRC message or may be specified by the RNTI scrambling.

### (5) APPLICABLE SCENES

As described above, the CC group includes a plurality of CCs, and the communication among the plurality of CCs is controlled using the DCI that is received via any one of the plurality of CCs included in the CC group.

Under such a background, the UE 200 may control the communication among the plurality of CCs as described below, according to the combination of the upper layer parameters and the DCI.

Firstly, the UE 200 may apply the same upper layer parameters for all the CCs so that the same resource is specified for all the CCs by the same information element included in the DCI received via one CC.

Secondly, the UE 200 may apply different upper layer parameters for each CC so that different resources are specified for each CC by the same information element included in the DCI received via one CC.

Thirdly, the UE 200 may apply different upper layer parameters for each CC so that different resources are specified for each CC by different information elements included in DCI received via one CC. In such a case, the DCI received via one CC may include a field for each CC.

The field size for each CC may be the same. For example, when the original field size is 3 bits and the number of CCs included in the CC group is 2, the field size included in the DCI is 6 bits (3 bits*2). Alternatively, the field size for each CC may be smaller than the original field size. For example, when the original field size is 3 bits, the field size for each CC may be 2 bits. In such a case, when the number of CCs included in the CC group is 2, the field size included in the DCI is 4 bits (2 bits*2).

The field size for each CC may be different. For example, when the original field size is 3 bits, there may be a mixture of CCs to which a 3-bit field is applied and CCs to which a 2-bit field is applied. When the 3-bit fill degree is applied to the CC #0 and the CC #1, and the 2-bit field is applied to the CC #2 and the CC #3, the field size included in the DCI is 10 bits (3 bits*2+2 bits*2).

In the following, the TDRA field, FDRA field, and MCS field are illustrated as the fields included in the DCI.

### (5.1) TDRA

First, a case where the TDRA field included in the DCI can take one value will be described.

The same time domain resource may be allocated to all the CCs included in the CC group. In such a case, the same pdsch-TimeDomainAllocationList or default table may be set for all the CCs. For example, when the DCI is received via the CC #0, the pdsch-TimeDomainAllocationList or default table set for the CC #0 may be applied to all the CCs. In such a case, even if a different pdsch-TimeDomainAllocationList or default table is set for each CC, the pdsch-TimeDomainAllocationList or default table set for the CC #0 may be applied to all the CCs.

Alternatively, different time domain resources may be allocated to all the CCs included in the CC group. In such a case, the same pdsch-TimeDomainAllocationList or default table may be set for all the CCs. Here, the row in the pdsch-TimeDomainAllocationList or in the default table is replaced with a different value for each CC. The value that differs for each CC may be a CC index that specifies a CC. Alternatively, a different pdsch-TimeDomainAllocationList or default table may be set for each CC included in the CC group. In such a case, the above-mentioned replacement may not be performed.

Secondly, a case where the TDRA field included in the DCI can take two or more values will be described. In such a case, the TDRA field includes an information element that specifies the TDRA for each CC. For example, when the number of CCs included in the CC group is four, the TDRA field includes four TDRA fields. That is, the TDRA field may include a TDRA field #0 for CC #0, a TDRA field #1 for CC #1, a TDRA field #3 for CC #3, and a TDRA field 4 for CC #4.

### (5.2) FDRA

First, a case where the FDRA field included in the DCI can take one value will be described. The same frequency domain resource may be allocated to all the CCs included in the CC group. In such a case, the value of the FDRA field included in the DCI received via one CC is applied to all the CCs. Alternatively, different frequency domain resources may be allocated to each CC included in the CC group. In such a case, different RA types are set for the plurality of CCs. For example, in the case of receiving the DCI via the CC #0, RA type 0 is set for the CC #0, RA type 1 is set for the CC #2, and the value of the FDRA field included in the DCI via the CC #0 is applied to the CC #0 and the CC #1.

Secondly, a case where the FDRA field included in the DCI can take two or more values will be described. In such a case, the FDRA field includes an information element that specifies the FDRA for each CC. For example, when the number of CCs included in the CC group is four, the FDRA field includes four FDRA fields. That is, the FDRA field may include an FDRA field #0 for CC #0, an FDRA field #1 for CC #1, an FDRA field #3 for CC #3, and an FDRA field 4 for CC #4.

Thirdly, a new RA type may be introduced as an RA type. The new RA type is the RA type applied to all the frequency domain resources included in the BWP.

For example, the RA type may be set for the plurality of CCs as described below.

First, the same RA Type may be set for all the CCs included in the CC group. For example, in the case of receiving the DCI via the CC #0, the RA type set for the CC #0 may be applied to all the CCs. In such a case, even if a different RA type is set for each CC, the RA type set for the CC #0 may be applied to all the CCs.

Secondly, a different RA type may be set for each CC included in the CC group. For example, RA type 0 may be set for the CC #0 and RA type 1 may be set for the CC #1. In such a case, RA type 0 is applied to the CC #0 and RA type 1 is applied to the CC #1.

The RA type may be specified by most significant bits (MSBs) included in the FDRA field included in the DCI.

### (5.3) MCS

First, a case where the MCS field included in the DCI can take one value will be described.

The same MCS may be applied to all the CCs included in the CC group. In such a case, the same MCS table may be set for all the CCs. For example, in the case of receiving the DCI via the C #0, the MCS table set for the CC #0 may be applied to all the CCs. In such a case, even if a different MCS table is set for each CC, the MCS table set for the CC #0 may be applied to all the CCs.

Alternatively, different MCSs may be applied to all the CCs included in the CC group. In such a case, the same MCS table may be set for all the CCs. The row of the MCS table is replaced with a different value for each CC. The value that differs for each CC may be a CC index that specifies a CC. Alternatively, a different MCS table may be set for each CC included in the CC group. In such a case, the above-mentioned replacement may not be performed.

Secondly, a case where the MCS field included in the DCI can take two or more values will be described. In such a case, the MCS field includes an information element that specifies the MCS for each CC. For example, when the number of CCs included in the CC group is four, the MCS field includes four MCS fields. That is, the MCS field may include an MCS field #0 for CC #0, an MCS field #1 for CC #1, an MCS field #3 for CC #3, and an MCS field 4 for CC #4.

### (6) SCHEDULING EXAMPLE

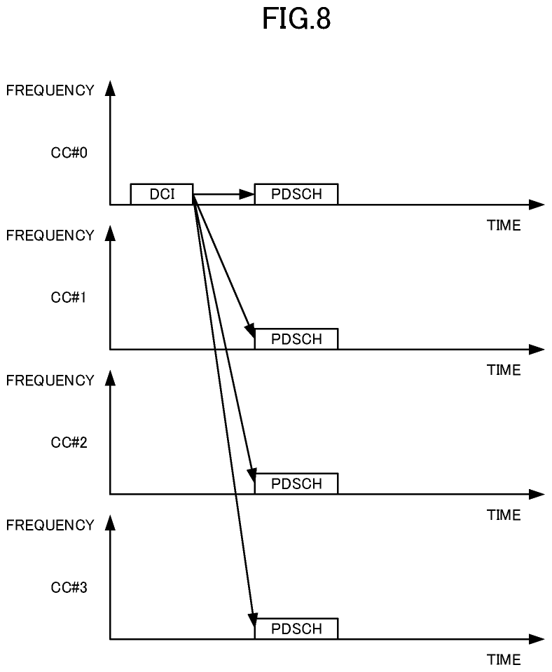

FIGS. 8 to 11 are diagrams illustrating an example of scheduling according to the embodiment. Here, a case where the CC group includes the CC #0 to the CC #3 and receives the DCI via the CC #0 will be exemplified. Here, the PDSCH is taken as an example, but the present embodiment may be applied to the PUSCH.

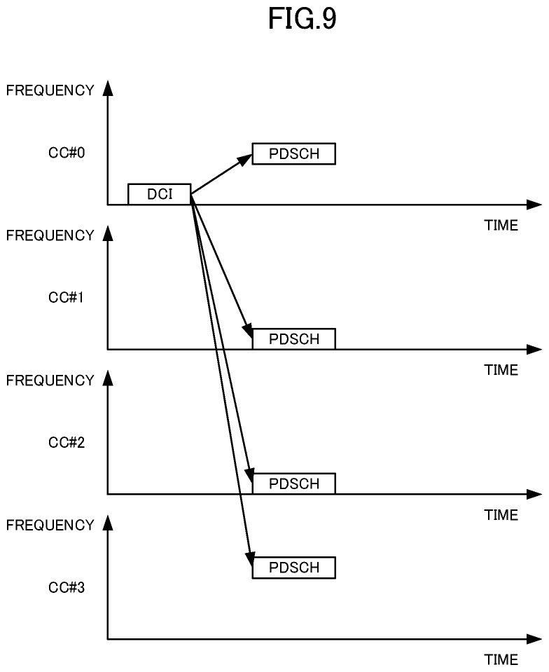

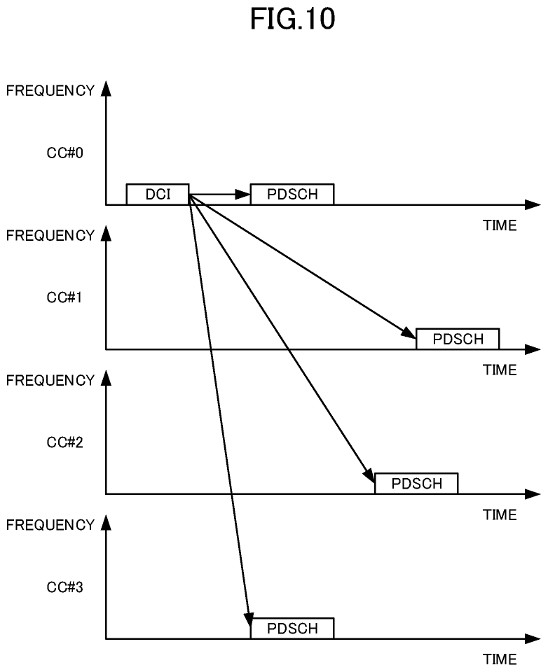

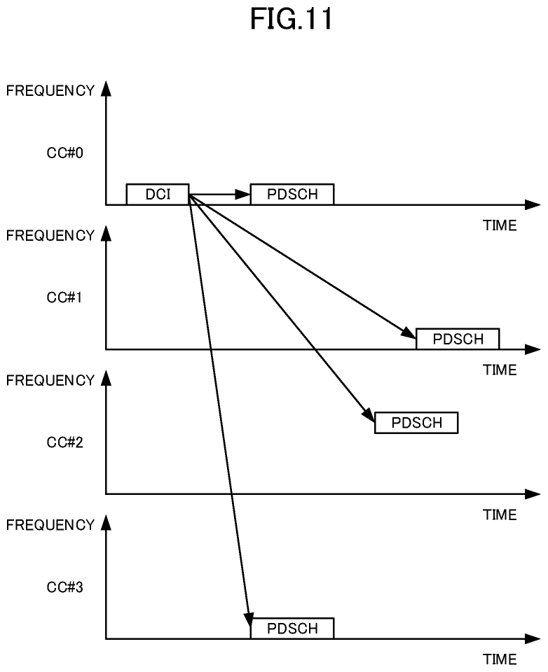

As illustrated in FIG. 8, the PDSCHs allocated to the CCs may be the same in frequency resource and time resource. As illustrated in FIG. 9, the PDSCHs allocated to the CCs may be different in frequency resource and may be the same in time resource. As illustrated in FIG. 10, the PDSCHs allocated to the CCs may be the same in frequency resource and may be different in time resource. As illustrated in FIG. 11, the PDSCHs allocated to the CCs may be different in frequency resource and time resource.

As described above, the scheduling examples illustrated in FIGS. 8 to 10 can be implemented by a combination of upper layer parameters and DCI.

### (7) OPERATION EXAMPLES

### (7.1) Operation Example 1

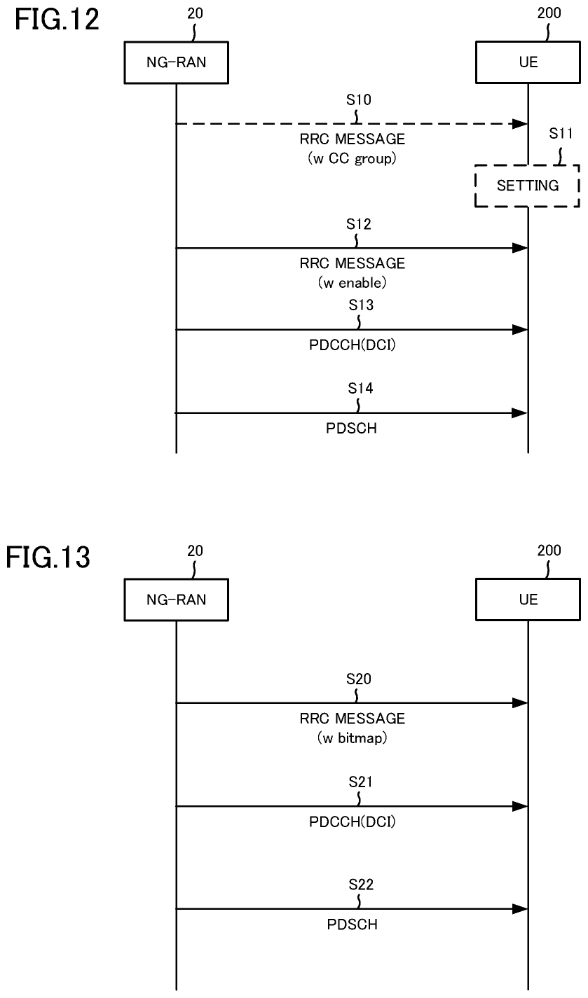

As illustrated in FIG. 12, in step S10, the UE 100 receives from the NG-RAN 20 an RRC message including an information element for specifying a CC included in a CC group. There may be one CC group (see FIG. 5) or two or more CC groups (see FIG. 6).

In step S11, the UE 200 sets the CC group based on the information element included in the RRC message received in step S10.

In step S12, the UE 200 receives from the NG-RAN 20 an RRC message including an information element for instructing on the application of the CC group. The CC group to be applied to the UE 200 may be selected from the CC groups set in step S10 or step S11. The information element for instructing on the application of the CC group may include identification information of the CC group to be applied to the UE 200 and indication that CC group should be applied (for example, enable).

In step S13, the UE 200 receives the DCI from the NG-RAN 20 via any one of the plurality of CCs included in the CC group.

In step S14, the UE 200 receives the PDSCH via the plurality of CCs included in the CC group. Here, the UE 200 controls communication among the plurality of CCs based on the DCI received in step S13. The control of communication may include scheduling of resources used in the CCs, and may include specification of the MCS applied to the CCs.

FIG. 12 exemplifies a case where the CC group is set by the RRC message, but the CC group may be predetermined and known to the UE 200. In such a case, steps S10 and S11 described above may be omitted.

FIG. 12 merely exemplifies the case where the CC group is applied. The CC group may not be applied. In such a case, the UE 200 receives from the NG-RAN 20 an RRC message that includes an information element for instructing on the non-application of the CC group in step S12. The information element for instructing on the non-application of the CC group may include identification information of the CC group not to be applied to the UE 200 and indication that CC group should be applied (for example, disable).

### (7.2) Operation Example 2

As illustrated in FIG. 13, in step S20, the UE 200 receives from the NG-RAN 20 an RRC message including an information element for instructing on the application of the CC group. The information element for instructing on the application of the CC group may be an information element that indicates whether each CC is included in the CC group. For example, the information element for instructing on the application of the CC group is bitmap information capable of specifying the CC by the bit position, and each bit indicates whether the CC corresponding to the bit position is included in the CC group. The information element for instructing on the application of the CC group may be a combination of CC identification information and an information element indicating whether the CC is included in the CC group.

In step S21, the UE 200 receives the DCI from the NG-RAN 20 via any one of the plurality of CCs included in the CC group.

In step S22, the UE 200 receives the PDSCH via the plurality of CCs included in the CC group. Here, the UE 200 controls communication among the plurality of CCs based on the DCI received in step S21. The control of communication may include scheduling of resources used in the CCs, and may include specification of the MCS applied to the CCs.

### (7.3) Operation Example 3

As illustrated in FIG. 12, in step S30, the UE 100 receives from the NG-RAN 20 an RRC message including an information element for specifying a CC included in a CC group. There may be one CC group (see FIG. 5) or two or more CC groups (see FIG. 6).

In step S31, the UE 200 sets the CC group based on the information element included in the RRC message received in step S10.

In step S32, the UE 200 receives the DCI from the NG-RAN 20 via any one of the plurality of CCs included in the CC group. The UE 200 specifies the CC group to be applied to the UE 200, based on the information element included in the DCI. For example, the UE 200 specifies the CC group to be applied to the UE 200, based on the CI stored in the CI field included in the DCI.

For example, taking the case illustrated in FIG. 6 as an example, when the CI has a value indicating the CC #0, the CC group to be applied to the UE 200 is the CC group #0 including the CC #0. On the other hand, when the CI has a value indicating the CC #5, the CC group to be applied to the UE 200 is the CC group #1 including the CC #0.

In step S33, the UE 200 receives the PDSCH via the plurality of CCs included in the CC group. Here, the UE 200 controls communication among the plurality of CCs based on the DCI received in step S32. The control of communication may include scheduling of resources used in the CCs, and may include specification of the MCS applied to the CCs.

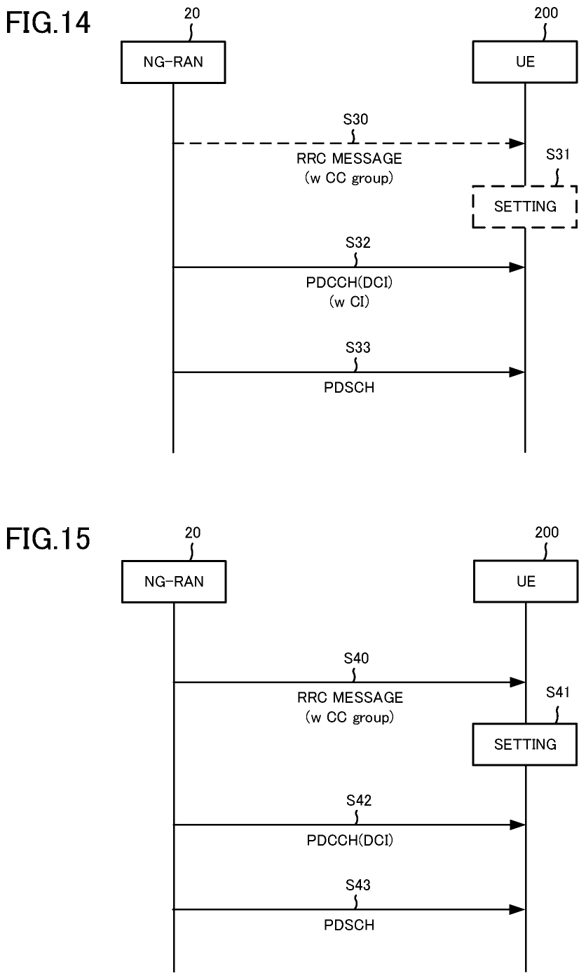

FIG. 14 exemplifies a case where the CC group is set by the RRC message, but the CC group may be predetermined and known to the UE 200. In such a case, steps S30 and S31 described above may be omitted.

### (7.4) Operation Example 4

As illustrated in FIG. 15, in step S40, the UE 100 receives from the NG-RAN 20 an RRC message including an information element for specifying a CC included in a CC group. There may be one CC group (see FIG. 5) or two or more CC groups (see FIG. 6).

In step S41, the UE 200 sets the CC group based on the information element included in the RRC message received in step S40. Here, the UE 200 applies the CC group at the same time as setting the CC group. That is, the procedure for applying the CC group to the UE 200 (for example, step S12 illustrated in FIG. 12) is omitted.

In step S42, the UE 200 receives the DCI from the NG-RAN 20 via any one of the plurality of CCs included in the CC group.

In step S43, the UE 200 receives the PDSCH via the plurality of CCs included in the CC group. Here, the UE 200 controls communication among the plurality of CCs based on the DCI received in step S42. The control of communication may include scheduling of resources used in the CCs, and may include specification of the MCS applied to the CCs.

### (8) OPERATION AND ADVANTAGEOUS EFFECT

In the embodiment, a new concept that a plurality of CCs (CC group) is controlled by DCI received via one CC is introduced, so that the UE 200 controls the CCs included in the CC group based on the DCI received via one CC. According to such a configuration, it is possible to realize efficient CC communication control using DCI even when a large number of CCs are set.

### Other Embodiments

The contents of the present invention have been described so far with reference to the embodiments. However, the present invention is not limited to these descriptions, and it is obvious to those skilled in the art that various modifications and improvements can be made.

In relation to the above-described embodiment, the RRC message and DCI have been mainly described, but the embodiment is not limited to this. For example, the UE 200 may apply the CC group based on the information element used in a MAC control element (CE).

The block diagram used for explaining the above-described embodiments (FIG. 4) illustrates blocks of functional unit. Those functional blocks (components) can be realized by a desired combination of at least one of hardware and software. A method for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that causes transmitting may be called a transmitting unit or a transmitter. For any of the above, as explained above, the realization method is not particularly limited.

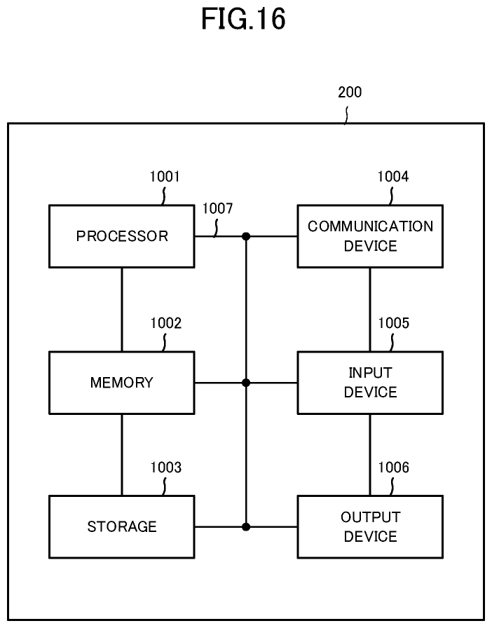

Furthermore, the UE 200 (the device) explained above can function as a computer that performs the processing of the radio communication method of the present disclosure. FIG. 16 is a diagram illustrating an example of a hardware configuration of the device. As illustrated in FIG. 16, the device can be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices illustrated in the figure, or can be constituted without including a part of the devices.

The functional blocks of the device (see FIG. 4) can be realized by any of hardware elements of the computer device or a desired combination of the hardware elements.

Moreover, the processor 1001 performs computing by loading a predetermined software (program) on hardware such as the processor 1001 and the memory 1002, and realizes various functions of the device by controlling communication via the communication device 1004, and controlling at least one of reading and writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a program (program code), a software module, data, and the like from at least one of the storage 1003 and the communication device 1004 into the memory 1002, and executes various processes according to them. As the program, a program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 can be called register, cache, main memory (main storage device), and the like. The memory 1002 can store therein a program (program codes), software modules, and the like that can execute the method according to the embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information therebetween. The bus 1007 can be constituted by a single bus or can be constituted by separate buses between the devices.

Further, the device is configured to include hardware such as a microprocessor, a Digital Signal Processor (DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Notification of information is not limited to that in the aspect/embodiment explained in the present disclosure, and may be performed by using a different method. For example, the notification of information may be performed by physical layer signaling (for example, Downlink Control Information (DCI), Uplink Control Information (UCI), upper layer signaling (for example, RRC signaling, Medium Access Control (MAC) signaling, broadcast information (Master Information Block (MIB), System Information Block (SIB)), other signals, or a combination of these. The RRC signaling may be called RRC message, for example, or can be RRC Connection Setup message, RRC Connection Reconfiguration message, or the like.

Each of the aspects/embodiments explained in the present disclosure can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

As long as there is no inconsistency, the order of processing procedures, sequences, flowcharts, and the like of each of the aspects/embodiments explained in the present disclosure may be exchanged. For example, the various steps and the sequence of the steps of the methods explained in the present disclosure are exemplary and are not limited to the specific order mentioned above.

The specific operation that is performed by the base station in the present disclosure may be performed by its upper node in some cases. In a network constituted by one or more network nodes having a base station, it is obvious that the various operations performed for communication with the terminal can be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information and signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by truth-value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Regardless of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like explained in the present disclosure may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced with terms having the same or similar meanings. For example, at least one of a channel and a symbol may be a signal (signaling). Also, a signal may be a message. Further, a component carrier (CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be represented by a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names allocated to these various channels and information elements shall not be restricted in any way.

In the present disclosure, it is assumed that the terms “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femto cell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of at least one of a base station and a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station may be called a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or some other suitable term by those skilled in the art.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration in which a communication between a base station and a mobile station is replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Likewise, a mobile station in the present disclosure may be read as a base station. In this case, the base station may have the function of the mobile station.

A radio frame may be composed of one or more frames in the time domain. Each one or more frames in the time domain may be called subframe.

A subframe may be composed of one or more slots in the time domain. The subframe may have a fixed time length (e.g., 1 ms) that does not depend on numerology.

The numerology may be a communication parameter applied to at least one of transmission and reception of a signal or channel. The numerology may indicate, for example, at least one of subcarrier spacing (SCS), bandwidth, symbol length, cyclic prefix length, transmission time interval (TTI), the number of symbols per TTI, radio frame configuration, a specific filtering process performed by a transceiver in the frequency domain, and a specific windowing process performed by the transceiver in the time domain.

The slot may be composed of one or more symbols (orthogonal frequency division multiplexing (OFDM) symbols, single carrier frequency division multiple access (SC-FDMA) symbols, etc.) in the time domain. The slot may be a time unit based on numerology.

The slot may include a plurality of minislots. Each minislot may be composed of one or more symbols in the time domain. The minislot may be called subslot. The minislot may be composed of a smaller number of symbols than slots. The PDSCH (or PUSCH) transmitted in a time unit larger than the minislot may be called PDSCH (or PUSCH) mapping type A. The PDSCH (or PUSCH) transmitted using the minislot may be called PDSCH (or PUSCH) mapping type B.

The radio frame, subframe, slot, minislot, and symbol all represent a time unit for transmitting a signal. The radio frame, subframe, slot, minislot, and symbol may have respectively different names corresponding to them.

For example, one subframe may be called transmission time interval (TTI), a plurality of consecutive subframes may be called TTI, and one slot or one minislot may be called TTI. That is, at least one of the subframe and the TTI may be a subframe (1 ms) in the existing LTE, or may be a period shorter than 1 ms (for example, 1-13 symbols), or may be a period longer than 1 ms. The unit representing TTI may be called slot, minislot, or the like instead of subframe.

TTI refers to, for example, the minimum time unit for scheduling in radio communication. For example, in the LTE system, the base station performs scheduling to allocate radio resources (frequency bandwidth that can be used in each user terminal, transmission power, etc.) to each user terminal at the TTI. The definition of TTI is not limited to this.

The TTI may be a transmission time unit of a channel-encoded data packet (transport block), code block, codeword, and the like, or may be a processing unit for scheduling, link adaptation, or the like. When a TTI is given, a time section (for example, the number of symbols) in which a transport block, code block, codeword, and the like are actually mapped may be shorter than the TTI.

When one slot or one minislot is called TTI, one or more TTIs (that is, one or more slots or one or more minislots) may be the minimum time unit for scheduling. Also, the number of slots (the number of minislots) constituting the minimum time unit for scheduling may be controlled.

A TTI having a time length of 1 ms may be called usual TTI (TTI in LTE Rel. 8-12), normal TTI, long TTI, usual subframe, normal subframe, long subframe, slot, or the like. A TTI shorter than the usual TTI may be called shortened TTI, short TTI, partial TTI (partial or fractional TTI), shortened subframe, short subframe, minislot, subslot, slot, or the like.

The long TTI (e.g., usual TTI, subframe, or the like) may be replaced with a TTI having a time length exceeding 1 ms, and the short TTI (e.g., shortened TTI or the like) may be replaced with a TTI having a length less than the length of the long TTI and equal to or greater than 1 ms.

The resource block (RB) is a resource allocation unit in the time domain and the frequency domain, and may include one or more contiguous subcarriers in the frequency domain. The number of sub-carriers included in the RB may be the same regardless of numerology, and may be, for example, 12. The number of sub-carriers included in the RB may be determined based on numerology.

The time domain of the RB may include one or more symbols, and may have a length of one slot, one minislot, one subframe, or one TTI. One TTI, one subframe, or the like may be formed by one or more resource blocks.

One or more RBs may be called physical resource block (PRB), sub-carrier group (SCG), resource element group (REG), PRB pair, RB pair, or the like.

The resource block may be formed by one or more resource elements (RE). For example, one RE may be a radio resource domain of one sub-carrier and one symbol.

A bandwidth part (BWP) (which may be called partial bandwidth or the like) may represent a subset of contiguous common resource blocks (RBs) for certain numerology in a certain carrier. Here, the common RB may be specified by an RB index with reference to a common reference point of the carrier. A PRB may be defined in a BWP and numbered within the BWP.

The BWP may include a BWP for UL (UL BWP) and a BWP for DL (DL BWP). For the UE, one or more BWPs may be set within one carrier.

At least one of the set BWPs may be active and the UE may not be assumed to transmit or receive a predetermined signal/channel outside the active BWP. The “cell”, “carrier”, and the like in the present disclosure may be replaced with the “BWP”.

The structures of the radio frame, subframe, slot, minislot, symbol, and the like described above are merely examples. For example, the number of subframes included in a radio frame, the number of slots per subframe or radio frame, the number of minislots included in a slot, the number of symbols and RBs included in a slot or minislot, the number of sub-carriers included in a RB, the number of symbols in a TTI, symbol length, cyclic prefix (CP) length, and the like can be variously changed.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using at least one of one or more wires, cables, printed electrical connections, and as some non-limiting and non-exhaustive examples, by using electromagnetic energy having wavelengths in the radio frequency domain, the microwave region and the light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each of the devices described above may be replaced with “unit”, “circuit”, “device”, or the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as “a”, “an”, and “the” in English are added, in this disclosure, these articles shall include plurality of nouns following these articles.

The term “determining” used in the present disclosure may encompass a wide variety of operations. The term “determining” here may mean, for example, determining that judging, calculating, computing, processing, deriving, investigating, looking up, search, inquiry (for example, searching a table, database, or other data structures), ascertaining has been done, or the like. The term “determining” here may also mean determining that receiving (for example, receiving information), transmitting (for example, transmitting information), input, output, or accessing (for example, accessing data in a memory) has been done, or the like. The term “determining” here may further mean determining that resolving, selecting, choosing, establishing, or comparing, or the like, has been done. That is, the term “determining” here may mean determining that some operation has been done. The term “determining” here may be replaced with “assuming”, “expecting”, “considering”, or the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 NG-RAN
100 gNB
200 UE
210 Radio signal transceiver
220 Amplifier
230 Modulator/demodulator
240 Control signal/reference signal processor
250 Encoder/decoder
260 Data transceiver
270 Controller
1001 Processor
1002 Memory
1003 Storage
1004 Communication device
1005 Input device
1006 Output device
1007 Bus

1. A terminal comprising:
a receiving unit that receives downlink control information from a network; and
a controller that, when a component carrier group formed from a plurality of component carriers is applied, uses the downlink control information received via any one of the plurality of component carriers to control communication among the plurality of component carriers.

2. The terminal according to claim 1, wherein the controller applies the component carrier group based on an information element included in an RRC message received from the network.

3. The terminal according to claim 1, wherein the controller sets the component carrier group based on an information element included in an RRC message received from the network.

4. The terminal according to claim 1, wherein the controller applies the component carrier group based on an information element included in the downlink control information.

5. The terminal according to claim 2, wherein the controller sets the component carrier group based on an information element included in an RRC message received from the network.
